(19) United States
(12) Patent Application Publication
(10) Pub. No.: US 2015/0317646 A1
(43) Pub. Date: Nov. 5, 2015

(54) TRANSFORMATION OF FINANCIAL TARGET AND QUOTA DEPLOYMENT

(71) Applicant: International Business Machines Corporation, Armonk, NY (US)

(72) Inventors: Debarun Bhattacharjya, New York, NY (US); Lena Granovsky, North Salem, NY (US); Saleem Hussain, Armonk, NY (US); Yingdong Lu, Yorktown Heights, NY (US); Irvin J. Lustig, Short Hills, NJ (US); Bonnie K. Ray, South Nyack, NY (US); Mark S. Squillante, Greenwich, CT (US); Xiaoting Wang, San Diego, CA (US)

(21) Appl. No.: 14/472,637

(22) Filed: Aug. 29, 2014

Related U.S. Application Data
(60) Provisional application No. 61/986,333, filed on Apr. 30, 2014.

(51) Int. Cl. G06Q 30/02; G06Q 40/00

(52) U.S. Cl. CPC G06Q 30/0201; G06Q 30/0202; G06Q 40/00

(57) ABSTRACT

One or more processors determine a financial target for a plurality of business accounts across a plurality of product brands that are included in a business account level of an organizational hierarchy of a business organization. The organizational hierarchy includes a plurality of levels. One or more processors determine respective financial targets and quotas for a plurality of nodes included in a level of the organizational hierarchy. One or more processors determine respective financial targets for combinations of business accounts and product brands. The determination of the financial targets is based on a statistical model that is fitted at a middle level of the organizational hierarchy, and a risk-based stochastic optimization that is used to set financial targets and quotas at one or more levels of the organizational hierarchy.

### BACKGROUND OF THE INVENTION

The present invention relates generally to the field of business management, and more particularly to setting of business goals.

The process of setting financial targets in business organizations is challenging. The larger the business organization becomes the more difficult it can be to adapt financial targets to changes in the environment of that business organization and to adapt to unpredicted results. Examples of financial targets that a business organization plans to reach can encompass areas such as growth and profitability, revenue targets, expense targets, and the like.

The hierarchical structure of large business organizations tends to be quite complex in practice, which in turn increases the complexity of distributing corporate revenue targets across the hierarchy and its various business dimensions. Examples of hierarchical structure of business organizations include business units, geographical regions, product brands, client segments and so on all the way down to the level of individual sellers. Examples of business dimensions include the markets served by each level of the hierarchy and the different stakeholders for each of these hierarchy levels.

### SUMMARY

Embodiments of the present invention provide a method, system, and program product for setting financial targets and quotas across multiple levels of an organizational hierarchy. One or more processors determine for a business organization, a financial target for a plurality of business accounts across a plurality of product brands that are included in a business account level of an organizational hierarchy of the business organization, wherein the organizational hierarchy includes a plurality of levels. One or more processors determine one or both of respective financial targets and quotas for a plurality of nodes included in a level of the organizational hierarchy. One or more processors determine respective financial targets for one or more combinations of business accounts and product brands, based, at least in part, on at least one of a statistical model that is fitted at a middle level of the organizational hierarchy and a risk-based stochastic optimization that is used to set financial targets and quotas at one or more levels of the organizational hierarchy.

### BRIEF DESCRIPTION OF THE SEVERAL VIEWS OF THE DRAWINGS

FIG. 1 is a functional block diagram illustrating a business computing environment, in accordance with an exemplary embodiment of the present invention.

FIG. 2 illustrates an example of a hierarchical structure of a business organization, in accordance with an exemplary embodiment of the present invention.

FIG. 3 illustrates an example of a matrix structure of a business organization, in accordance with an exemplary embodiment of the present invention.

FIG. 4A presents a plot of values of example revenues that are aggregated, by a target and quota-setting program, to the middle level of the hierarchy for one particular node, in accordance with an exemplary embodiment of the present invention.

FIG. 4B presents a plot of the log transformed example revenue values generated by a target and quota-setting program, in accordance with an exemplary embodiment of the present invention.

FIG. 5 illustrates operational processes of a target and quota-setting program, executing on a computing device within the environment of FIG. 1, in accordance with an exemplary embodiment of the present invention.

FIG. 6 depicts a block diagram of components of the computing device executing a target and quota-setting program, in accordance with an exemplary embodiment of the present invention.

### DETAILED DESCRIPTION

Embodiments of the present invention recognize that since the hierarchical structure of large organizations tends to be quite complex in practice, the distribution of corporate financial targets across the hierarchy and its various dimensions is often a challenging and complex problem to solve. Embodiments of the present invention recognize that one challenging aspect is that the financial targets for every element of the organizational hierarchy need to be fully aligned across the business structure and its dimensions such that aggregation of the target values at different elements of the structure are consistent while meeting business objectives and constraints.

An embodiment of the present invention provides a general approach based on analytics and optimization to address these core business challenges in order to improve the effectiveness and efficiency of the target setting process. An embodiment of the present invention provides a method to statistically predict the amount of financial target, such as revenue, that can be achieved based on forward-looking estimates of financial opportunity and historically realized financial targets. An embodiment of the present invention provides a method to optimize the reconciliation of these predictions across different levels of the business hierarchy and various dimensions of the business. Embodiments of the present invention provide a combination of statistical and optimization methods to achieve the optimal interlock of targets across different hierarchical levels and business dimensions, subject to business constraints, where interlocking resolves any conflicts among the target settings for different levels of the business hierarchy and makes these targets consistent with each other. An embodiment of the present invention provides a method for setting financial targets across a business hierarchy and various dimensions of the business. An embodiment of the present invention uses these targets as a basis for the financial quotas of individual sellers.

The present invention will now be described in detail with reference to the Figures.

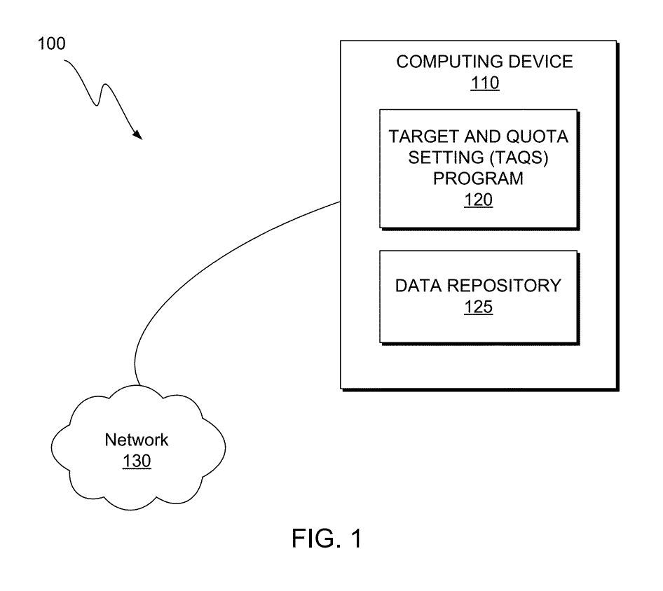

FIG. 1 is a functional block diagram illustrating a business computing environment, generally designated 100, in accordance with one embodiment of the present invention. Business computing environment 100 includes computing device 110 connected to network 130. Computing device 110 includes target and quota-setting (TAQS) program 120 and data repository 125. In general, business computing environment 100 represents a computing infrastructure, such as those used by business organizations, e.g., corporations.

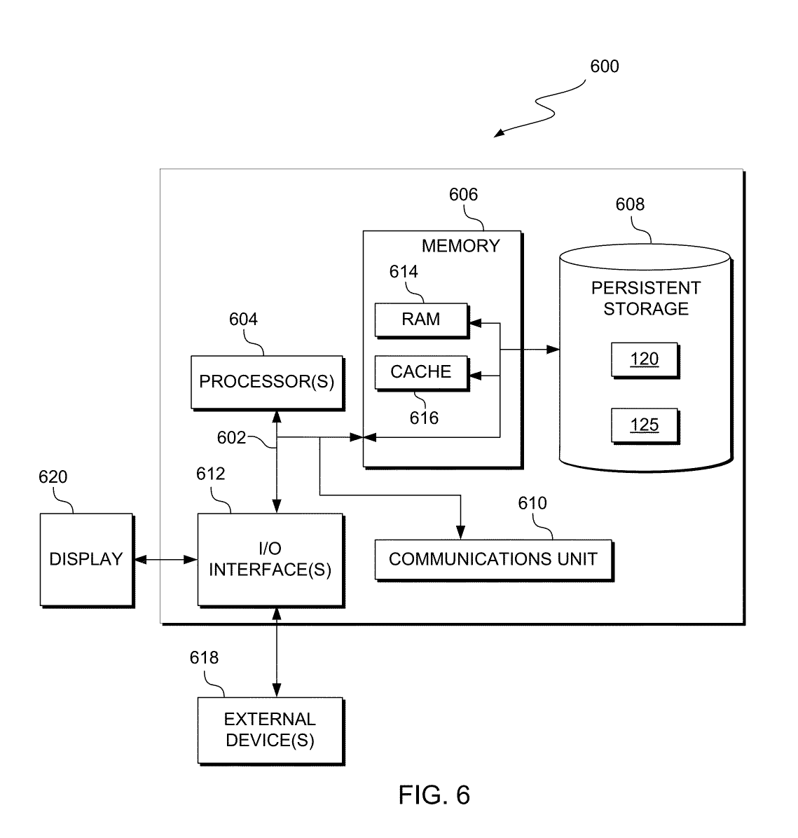

In various embodiments of the present invention, computing device 110 is a computing device that can be a standalone device, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 represents any computing device or a combination of devices with access to TAQS program 120 and data repository 125 and is capable of executing TAQS program 120. In one embodiment, computing device 110 includes internal and external hardware components, as depicted and described in further detail with respect to FIG. 6.

In this exemplary embodiment, TAQS program 120 and data repository 125 are stored on computing device 110. However, in other embodiments, TAQS program 120 and data repository 125 are stored externally and accessed through a communication network, such as network 130. Network 130 can be, for example, a local area network (LAN), a wide area network (WAN) such as the Internet, or a combination of the two. In certain embodiments, network 130 includes one or more of wired, wireless, fiber optic or any other connection known in the art. In general, network 130 is any combination of connections and protocols that will support communications between computing device 110 and TAQS program 120 and data repository 125, in accordance with a desired embodiment of the present invention.

In an embodiment, data repository 125 is a data store that is accessible by TAQS program 120. Data repository 125 includes historical and opportunity data for business organization ABC as described below in at least Sections 1, 2 and 3. This data includes historical revenues (a type of financial target) as well as the historical achievement records relating to various aspects of business organization ABC. It is to be understood that the type of information included in other embodiments is not limited to data regarding a single business organization. As such, in other embodiments, data repository includes a variety of data in accordance with a desired embodiment of the present invention.

In an embodiment, TAQS program 120 is a software tool that automates the revenue target and quota-setting process across all levels of the business hierarchy, including the support of sales managers in setting seller-level quotas based on client account-level targets and seller account assignments. As used herein, the notion of quota simply refers to the revenue target assigned to an individual seller, together with other financial and performance targets and incentives. Although examples and embodiments herein place focus on revenue targets throughout this description, the approach described herein is applicable to any scenario requiring the setting of financial targets across elements of an organizational hierarchy.

The following discussion of the functioning of an embodiment of TAQS program 120 is broken into three sections for ease of understanding. Section 1 addresses the broader business environment and context for the overall process of setting revenue targets and seller quotas as encountered by an embodiment of TAQS program 120, in the business computing environment 100 of FIG. 1. Section 2 presents a more detailed description of the technical problems and mathematical solutions for the statistical and optimization components of an approach utilized by an embodiment of TAQS program 120. Section 3 presents technical details of an implementation of these methods as part of an embodiment of TAQS program 120.

### Section 1:

The general process of setting financial targets is typically difficult, and that difficulty is often exacerbated in the case of complex organizational structures that are common in large business organizations such as corporations. In the following description, the structure of an example organization is assumed to be hierarchical in nature, which is also common in large corporations, either explicitly or implicitly. However, it should be noted that the approach described herein also applies more generally to any connected graph of business entities. An organizational structure in turn determines the business entities, or nodes, of the hierarchy for which revenue targets and quotas need to be set as well as the relationships among these targets and quotas. There are many forms for a hierarchical structure of an organization. For example, one hierarchical structure is arranged in the form of a tree where every node, except for the root, is subordinate to (or a child of) another node. In another example, the hierarchical structure is arranged in a matrix form such that two or more separate entities of the business are combined.

In many scenarios, a complex organizational structure results from an inherently complicated business process, and is generally used to set the quotas for different types of sellers. A first seller type of seller is herein called a “coverage seller”. A coverage seller sells products across all kinds of product brands to a group of client accounts that comprise their sales territory, which defines the collection of client accounts assigned to that seller as determined by a separate territory optimization step. The second seller type is called a “specialty seller”. A specialty seller specializes in selling products within a specific product brand, either within a specific account or across multiple client accounts, which, in some cases, span multiple customer sets.

In the example organization, the general process of setting revenue targets and quotas is carried out across its complex organizational structure in the following manner. First, different stakeholders within the business determine revenue targets at certain levels specific to their perspective of the business hierarchy. In an embodiment, TAQS program 120 makes statistical predictions for achievable revenues at the desired levels of the hierarchy, followed by an optimization of the reconciling and splitting of revenue targets at each level of the hierarchy, which are subject to the budgetary constraints from higher levels. In this example, from the perspective of each stakeholder within the business organization, the statistical predictions characterize the achievable revenue potential for the business as a whole and the market it serves, through achievable revenue potential for different functional and geographical levels of the hierarchy and the markets they serve based on the stakeholder perspective, down to achievable revenue potential for an individual seller and the set of client accounts assigned to the seller. In an embodiment, TAQS program 120 uses this set of statistical predictions and corresponding budgetary constraints as input, and applies stochastic optimization to set the revenue targets for every node of the business hierarchy, including the quota for each individual seller, from the perspective of each stakeholder within the business. The goal of each such stochastic optimization is, for example, to maximize revenue based on an objective function that incorporates the likelihood of achieving the targets or quotas across all nodes of the business hierarchy.

In an embodiment, TAQS program 120 uses subsequent steps to determine the final set of revenue targets for every node of the business hierarchy. These steps consist of a general revenue target and quota-setting process, which include interlocking the results of the first step across all of the different stakeholder perspectives. The notion of interlock, as used herein, specifically refers to combining multiple sets of revenue targets from different stakeholder perspectives into a single set of revenue targets that take into account each of these perspectives. As such, the use of interlocking to determine the final set of revenue targets for every node of the business hierarchy involves an optimization process. Such optimization processes are included as part of each interlock that is consistent with the constraints and objectives of each stakeholder within the business.

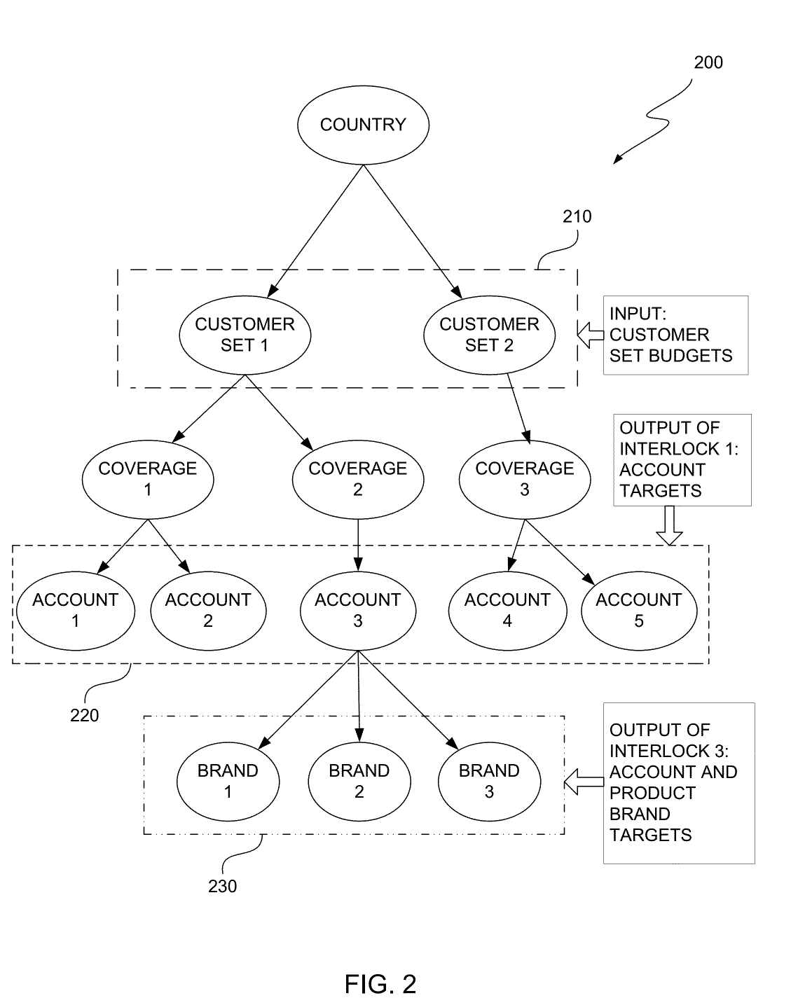

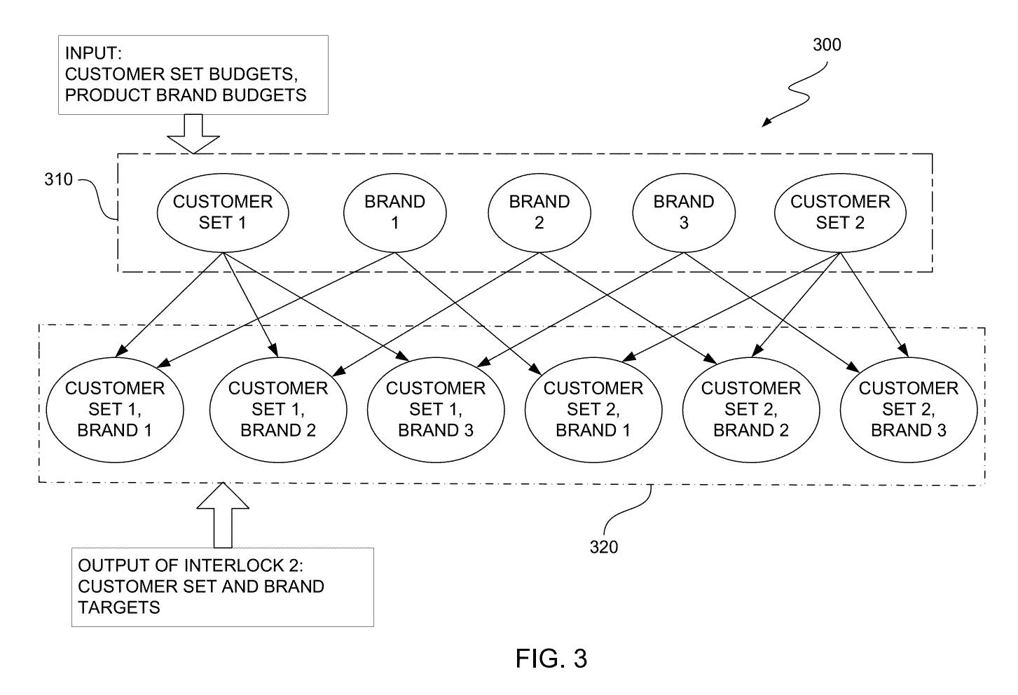

FIG. 2 illustrates an example of a hierarchical structure of a business organization, 200, in accordance with an exemplary embodiment of the present invention. To elucidate the exposition of the general process of setting financial targets and seller quotas, the following examples of the above concepts are described within the context of a business organization herein denoted “ABC”. As such, in FIG. 2, the hierarchical structure of business organization ABC is illustrated, which includes example inputs and outputs used in the process of setting revenue targets and quotas. Further, FIG. 2 illustrates the tree-like form of the hierarchical structure, where business accounts are grouped by coverage units (client accounts), which are in turn grouped into customer sets. FIG. 3 illustrates an example of a matrix structure, 300, of a business organization, in accordance with an exemplary embodiment of the present invention. FIG. 3 illustrates the matrix form of the hierarchical structure, where customer sets and product brands are combined into customer-set and product brand nodes. This organizational structure of business organization ABC is the result of an inherently complicated business process used to set quotas for coverage and specialty sellers, where the sales territory for each seller is determined by a territory optimization step of the overall sales model process of business organization ABC. FIG. 3 further illustrates examples of inputs and outputs used in the process of setting revenue targets and quotas, specifically, those for business organization ABC. Together, FIG. 2 and FIG. 3 illustrate various aspects of the complex organizational structure of business organization ABC that have been used as part of an ongoing transformation initiative regarding the business organization ABC revenue target and quota-setting process.

The process of TAQS program 120 setting revenue targets and quotas within business organization ABC then proceeds across the complex organizational structure of business organization ABC. In one embodiment, the first step of the process utilized by TAQS program 120 is herein called Interlock 1. In one embodiment, during the execution of Interlock 1, TAQS program 120 determines revenue targets at the account level across different product brands, where achievable revenue targets are statistically predicted at the coverage level by TAQS program 120. In one embodiment, TAQS program 120 performs reconciliation on the revenue targets at the coverage level using stochastic optimization, such reconciliation is based on the budgets provided at the customer-set level (see FIG. 2, dashed box 210, which is described as “input: customer set budgets”). The notion of budget, as used herein, is used as a constraint such that the revenue targets for all coverage units in the customer set must sum up to at least the given budget. The reconciled revenue targets at the coverage level are then split into business accounts (as seen in dashed box 220 of FIG. 2, described as “output of interlock 1: account targets”), and provided to the corresponding account managers to support the setting of appropriate revenue targets at the account level. As such, in one embodiment, TAQS program 120 is configured to, and has the functionality to, schedule meetings between various individuals, such as account managers for business organization ABC, and to supply the results produced by TAQS program 120, via Interlock 1, to those individuals. In one scenario, such managers incorporate their local knowledge and business acumen to improve upon these recommendations and finalize the account-level revenue targets. Once interlocked, these numbers are fixed throughout the remainder of the process.

In one embodiment, the second step of the process utilized by TAQS program 120 is herein called Interlock 2. In one embodiment, during the execution of Interlock 2, TAQS program 120 performs the processes of Interlock 2 in parallel with or subsequent to the Interlock 1 processes. During Interlock 2, TAQS program 120 applies risk-based stochastic optimization to provide guidance on revenue targets for each combination of customer set and product brand subject to budgetary constraints for each customer set and each product brand (see FIG. 3). In one scenario, meetings are held between the product brand and territory managers to discuss and finalize the setting of such revenue targets as part of the Interlock 2 step, at the end of which the revenue targets for each combination of customer set and product brand are set while satisfying the corresponding budgetary constraints. As such, in one embodiment, TAQS program 120 is configured to, and has the functionality to, schedule meetings between various individuals, such as members of management for business organization ABC, and to supply the results produced by TAQS program 120, via Interlock 2, to those individuals. As is seen in FIG. 3, the input of Interlock 2 is both customer and product brand budgets, as illustrated by dashed box 310, described as “input: customer set budgets, product brand budgets.” The output of Interlock 2, of TAQS program 120, is customer set and product brand targets, as illustrated by dashed box 320 in FIG. 3, described as “output of interlock 2: customer set and product brand targets.”

In one embodiment, the third step of the process utilized by TAQS program 120 is herein called Interlock 3. In one embodiment, during the execution of Interlock 3, TAQS program 120 determines the revenue targets for each combination of account and product brand (as illustrated by dashed box 230 of FIG. 2, which is described as “output of interlock 3: account and product brand targets). Here, optimization is used to take the account-level targets created as part of Interlock 1 and split them into revenue targets at the account and product brand level while satisfying the constraints imposed by the targets at the customer set and product brand level as determined as part of Interlock 2. In one scenario, much like in the earlier steps of the target setting process, these results on revenue targets at the account-product brand level are used to provide support to managers in their setting of quotas for individual sellers based on the business accounts comprising the seller territory and any specialty assignments.

The above description presents the details of a general analytics-based approach developed and deployed as part of the above target and quota-setting process within business organization ABC, in accordance with an example embodiment of TAQS program 120 executing on computing device 110, in business computing environment 100. Although certain aspects of this process are unique to business organization ABC, the basic approach and concepts employed in the process (as well as transitions among the steps employed) are applicable to other target and quota-setting problems.

### Section 2:

In this embodiment, the general analytics-based approach of TAQS program 120, discussed herein, consists of determining initial financial targets based on revenue predictions at certain levels of the business hierarchy specific to various stakeholder perspectives, reconciling and splitting these predicted revenue numbers and budgetary constraints from the different business stakeholder perspectives, and interlocking these results across the different stakeholder perspectives to determine the final set of revenue targets for all levels of the business hierarchy.

This section further includes a more detailed description of the technical problems and mathematical solutions associated with each of these aspects of the general approach, starting with statistical prediction, moving to various forms of optimization, and then ending with the design, components and capabilities of TAQS program 120 implementation and deployment. In each case, a generic description of the general approach is presented followed by specific illustrative examples within the context of business organization ABC.

### Statistical Analysis and Models:

The analytics that support the statistical analyses conducted as part of the target and quota-setting process provide revenue predictions and estimation of probability distributions that characterize the likelihood of achieving any revenue value at a certain level of the business hierarchy. This includes a set of probability distributions {D_{(i,j),k}} for estimating (potential) revenue achievement by every business entity i in market entity j at level k of the business hierarchy. These sets of probability distributions may be conditional on the target set for each node (i, j) at level k of the hierarchy, thus characterizing the revenue risk profiles for every business-market entity pair within the target and quota-setting process where risks are associated with underachieving revenue potential by setting targets too high or too low. The estimated set of probability distributions is in turn provided as input to risk-based stochastic target and quota-setting optimization. A description is presented in the following paragraphs that illustrates a variety of statistical analysis approaches and models and their respective advantages and disadvantages.

Historically, different statistical approaches have been applied for the hierarchical prediction used in a target setting process. For example, top-down methods fit a prediction model at the top of the hierarchy to the completely aggregated data, and distribute the predictions to the disaggregated levels of the hierarchy. The small number of observations and predictor variables, and the loss of information due to data aggregation are disadvantages of the top-down principle. In contrast, “bottom-up” methods fit a model at the lowest level of the hierarchy, and accumulate the predictions to the higher levels. However, fitting a reliable model at the lowest level of the hierarchy is often hard due to the noisy nature of the collected data. “Middle-out” methods fit a model at a desired middle level, and then derive predictions for the aggregated levels using the bottom-up principle, and predictions for the disaggregated levels using the top-down principle. In contrast to the above historically used statistical approaches, in various embodiments of TAQS program 120, a statistical model is fitted at the middle level of the business hierarchy, and a risk-based stochastic optimization is used to set target and quota at the remaining levels of the hierarchy.

In various embodiments, multiple linear regression methods are used to fit a predictive model of the revenue for each node (i, j) at level k and possible predictor variables, whose values are hypothesized to influence that predictive model. In general, the purpose of regression is to learn about the relationship among the response and one or more predictor variables. Multiple linear regression is a specific case of regression methods, which model these relationships among the response and two or more predictor variables by fitting a linear equation to the observed data. The candidate predictor variables are chosen to cover both what the business unit is capable of selling and what its market is capable of buying. Examples of such variables include historical revenues, opportunity, client wallet data, market share, financial indicators for the company, and so on.

In some embodiments, the nodes are classified into groups (such as new nodes, “large deal” nodes, etc.), and one or more of different regression models, predictor variables and data adjustments are used for different types of nodes. In some embodiments, analyzing each type of node separately provides a more accurate set of revenue predictions.

In some embodiments, in addition to predicting the revenue, the variance of the predicted number for each node (i, j) at level k is calculated, providing information indicating a degree of confidence that TAQS program 120 determines for the prediction. High variance indicates that, based on the observed data, the real revenue might be far away from the predicted number, while low variance indicates that the two numbers will be most probably close to each other. In the case of a sufficiently big data set, a prediction of the revenue and estimation of variance allows TAQS program 120 to estimate the set of revenue risk profiles {D_{(i,j),k}} for each node (i, j) at level k.

The paragraphs that follow illustrate a specific example of statistical revenue prediction within the context of business organization ABC for the year of 2013. Although concentration is placed on a specific fictitious year and predictor variables, it is to be appreciated that this general approach is applicable to different years and predictor variables in a straightforward manner.

In general, TAQS program 120 takes two steps to use regression analysis for revenue prediction, namely estimation and prediction. For the estimation step, historical data is collected both on the revenue and candidate predictor variables. A linear function is then hypothesized for the postulated causal relationship between the revenue and candidate predictor variables, and the parameters of the function are estimated from the data—that is, the parameters are chosen to optimize, in some way, the fit of the function to the data. For the prediction step, values of the predictor variables that are deemed relevant to future revenue are used in the fitted function to generate the prediction.

In an embodiment, TAQS program 120 conducts the estimation step of the regression analysis by collecting data on 2012 revenues and candidate predictor variables, and aggregating them to the middle level k of the hierarchy. These variables include historical revenues for years 2011, 2010, 2009, opportunity for 2012 (set at 2011), client wallet data, industry type, and more. In an embodiment, TAQS program 120 uses outlier detection methods to identify outliers in the data. In an embodiment, TAQS program 120 defines outliers as observations numerically distant from the rest of the data and, in some cases, occur because of inconsistencies in the data or incorrect recording. In an embodiment, TAQS program 120 treats observations with zero revenues as special cases and removes them from the data set.

In one example, TAQS program 120 identifies a special group of the recent “mega deal” nodes from the data. The historical revenue data collected for these nodes included “non-typical” very high revenues, caused by large, one-time deals that are statistically above average in terms of revenue gained. In an embodiment, in order to reduce skewing of the prediction by such outliers, TAQS program 120 adjusts or removes these types of “non-typical” revenues from the data set.

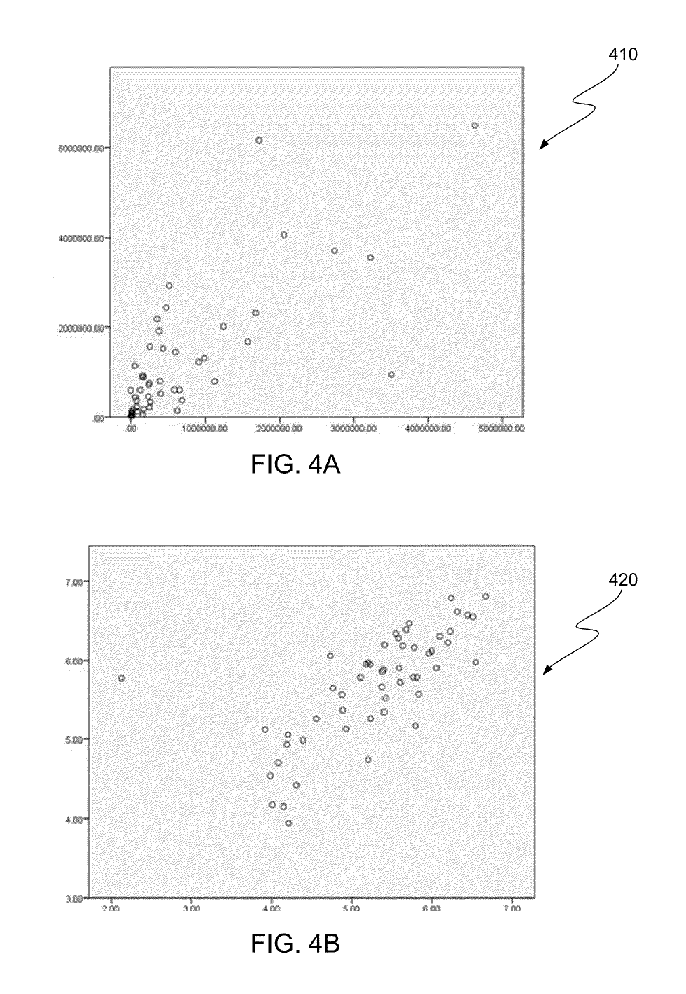

An underlying assumption of the linear regression is that the variance of the response variable is constant across the range of values. As used herein, variance is a measure of the spread of a set of numbers. In some cases, a small variance indicates that the data points tend to be very close to each other, while a high variance indicates that the data points tend to have a large spread. FIG. 4A presents a plot, 410 of values of example revenues that TAQS program 120 has aggregated to the middle level of the hierarchy, for one particular node, in accordance with an exemplary embodiment of the present invention. In this example, plot 410 represents the revenues of business organization ABC for the year 2012. Plot 410 indicates that the variance of the observed data increases as the revenue increases. It also shows a clumping of the data together at the lower range of numbers. In one embodiment, to solve this problem, TAQS program 120 transforms the observed values using a logarithmic transformation. The logarithmic scale amplifies the details in the lower range of the data and changes the variation of log revenues such that they are similar at different ranges of the values.

FIG. 4B presents a plot, 420, of the log transformed example revenue values generated by TAQS program 120, in accordance with an exemplary embodiment of the present invention.

In one embodiment, TAQS program 120 conducts the estimation step of the regression analysis by hypothesizing a number of models to fit the relationship between the log-transformed 2012 revenue and a number of different predictor variables. In one embodiment, TAQS program 120 uses a goodness of fit measure to compare the models. The results show that the log transformed average of 2009, 2010, 2011 revenues and log transformed 2012 opportunity are sufficient to explain the log-transformed 2012 revenue, assuming the following model:

Y_{(i,j),k}=β₀+β₁X_{1(i,j),k}+β₂X_{2(i,j),k}+ε_{(i,j),k}

where Y_{(i,j),k} denotes the log of 2012 revenue for node (i, j) at level k, X_{1(i,j),k} denotes the log of the average of three years of historical revenues (from 2009 to 2011), X_{2(i,j),k} is the log of 2012 opportunity, and ε_{(i,j),k} is a random error term. In one embodiment, TAQS program 120 estimates regression coefficients β₀,β₁,β₂ in a way that optimizes the fit of the function to the observed data. In one embodiment, TAQS program 120 estimates variance from the data under the assumption that the error term ε_{(i,j),k} has a constant variance for every node (also called an MSE).

In one embodiment, TAQS program 120 conducts the prediction step next to estimate the log of 2013 revenue. Values of the predictor variables are used to generate the prediction, using the following equation:

ŷ_{(i,j),k}|x_{1(i,j),k},x_{2(i,j),k}=\hat{β}₀+\hat{β}₁x_{1(i,j),k}+\hat{β}₂x_{2(i,j),k}

In this equation, ŷ_{(i,j),k} is the predicted log of 2013 revenue for node (i, j) at level k, given the log of the average of 2012, 2011, 2010 historical revenues x_{1(i,j),k}, and log of 2013 opportunity X_{2(i,j),k} (set in 2012). The estimates of the regression coefficients \hat{β}₀, \hat{β}₁, \hat{β}₂ are calculated in the estimation step, and the average value of the error term is assumed to be zero.

In one embodiment of TAQS program 120, in addition to predicting, ŷ_{(i,j),k} its variance, \hat{σ}_{(i,j),k}², is also calculated, providing information regarding the degree of confidence associated with the prediction. In one embodiment of TAQS program 120, given a sufficiently large number of the observations, TAQS program 120 uses ŷ_{(i,j),k} and \hat{σ}_{(i,j),k}² to estimate the set of revenue risk profiles {D_{(i,j),k}} for each node (i, j) at level k.

Note that, in one embodiment of TAQS program 120, the results produced at this step are the basis for the next stages of reconciliation with business constraints and distribution of targets to the different levels of the hierarchy.

### Risk-Based Stochastic Optimization:

In one embodiment, the analytics that support the risk-based stochastic optimization of target and quota-setting within the general process of TAQS program 120 increase and maximize revenue by optimizing objective functions that incorporate the likelihood of achieving the targets and quotas at every node of the business hierarchy. The following sub-sections describe such analytics for various steps of the general revenue target and quota-setting process, in accordance with an embodiment of the present invention.

### First Step of Target and Quota-Setting Process:

In this embodiment of TAQS program 120, in support of the first step of the general process, risk-based stochastic optimization takes as input the set of (conditional) probability distributions {D_{(i,j),k}} from the foregoing statistical analysis and models for a given stakeholder within the business, and then determines the corresponding revenue targets T_{(i,j),k} (including the quota for an individual seller) from this stakeholder perspective. Recall that the input probability distributions represent characterizations of the revenue risk profiles for every business-market entity pair (i, j), where risks are associated with underachieving revenue potential by setting targets too high or too low.

More specifically, a risk-based stochastic optimization problem is formulated and solved to determine the targets and quotas T_{(i,j),k} for each node (i, j) across all levels k of the organizational hierarchy from the perspective of a given business stakeholder, with the objective of maximizing a weighted sum of functional(s) of the likelihood of achieving revenue targets over a given planning horizon. Let K denote the number of levels comprising the business hierarchy and Sₖ={(i, j)} denote the set of nodes comprising hierarchy level k=1, . . . ,K. Define χₖ(i′, j′)εSₖ₊₁ to be the set of children business-market entity pairs {(i, j)} on level k+1 for each node (i′, j′)εSₖ on level k. Given the revenue risk profiles D_{(i,j),k} for each business-market entity pair on every level of the business hierarchy, a general formulation of interest by TAQS program 120 for risk-based stochastic optimization is given by:

$$\begin{matrix} {max}_{T} {\sum }_{k = 1}^{K} {\sum }_{( i , j ) ∈ {S}_{k}}^{ } {w}_{( i , j ) , k} {g}_{( i , j ) , k} ( {D}_{( i , j ) , k} , {T}_{( i , j ) , k} ) & ( 2.2 .1 ) \\ s . t . {\sum }_{( i , j ) ∈ {χ}_{k - 1} ( {i}^{′} , {j}^{′} )}^{ } {T}_{( i , j ) , k} = {T}_{( {i}^{′} , {j}^{′} ) , k - 1} , \\ ∀ ( {i}^{′} , {j}^{′} ) ∈ {S}_{k - 1} , ∀ k = 2 , … , K , & ( 2.2 .2 ) \\ {max}_{( i , j ) ∈ {χ}_{k - 1} ( {i}^{′} , {j}^{′} )} \{ P [ {D}_{( i , j ) , k} \geq {T}_{( i , j ) , k} ] \} - {min}_{( i , j ) ∈ {χ}_{k - 1} ( {i}^{′} , {j}^{′} )} \{ P [ {D}_{( i , j ) , k} \geq {T}_{( i , j ) , k} ] \} \leq {F}_{k} , \\ ∀ ( {i}^{′} , {j}^{′} ) ∈ {S}_{k - 1} , ∀ k = 2 , … , K . & ( 2.2 .3 )\end{matrix}$$

In some embodiments, this general formulation is used at any level of the business hierarchy (as shown later) for reconciliation of top-down and bottom-up targets and quotas.

In the above formulation, the decision variables are the revenue targets and quotas T_{(i,j),k} for the entire organizational hierarchy, denoted by the vector T in the objective function (2.2.1), with g_{(i,j),k}(•,•) and w_{(i,j),k} reflecting the functional(s) of interest and the weights of relative importance, respectively, for node (i, j) on level k. Two representative functional(s) of interest are generically related to tail probabilities and integrated tail distributions, such as

$$\begin{matrix}{g}_{( i , j ) , k} ( {D}_{( i , j ) , k} , {T}_{( i , j ) , k} ) \text{:=} P [ {D}_{( i , j ) , k} \geq {T}_{( i , j ) , k} ] & ( 2.2 .4 ) \\ and & \\ {g}_{( i , j ) , k} ( {D}_{( i , j ) , k} , {T}_{( i , j ) , k} ) \text{:=} {\int }_{{T}_{( i , j ) , k}}^{∞} t \cdot d P [ {D}_{( i , j ) , k} \geq t ] , & ( 2.2 .5 )\end{matrix}$$

respectively. The first constraint (2.2.2) ensures that the target and quota for each node at every level of the hierarchy is equal to the sum of the targets and quotas for its children nodes at the next level of the hierarchy. The second constraint (2.2.3) addresses fairness in the likelihood of achieving the revenue target and quota for each node at every level of the hierarchy, where Fₖ denotes the threshold for the fairness constraint on level k; this constraint enables the business to take into consideration the tradeoff between maximizing the overall likelihood, possibly with large differences in likelihood among peers, and minimizing the differences in likelihood among peers, possibly with large reductions in overall likelihood.

In some embodiments, whenever the probability distributions D_{(i,j),k} are identical for all nodes (i, j) on a given level k, then the optimal solution (focusing only on level k) is to set the targets T_{(i,j),k} in a proportional manner relative to the means of their corresponding distributions. Analogously, in some embodiments, if D_{(i,j),k} are normal distributions and the parent target at level k−1 is equal to the sum of the means of these normal distributions, then the optimal solution (focusing solely on level k) is to set each target T_{(i,j),k} equal to the mean of the distribution D_{(i,j),k}. In both of these cases, only the means of the probability distributions D_{(i,j),k} are required. However, in general, a more optimal target and quota-setting solution is a more detailed functional of the distributions D_{(i,j),k} for every node (i, j) across all levels of the business hierarchy.

In some embodiments or scenarios, TAQS program 120 optimally sets the revenue targets and quotas for all nodes of the organizational structure by taking into account the revenue risk profiles of each business entity and its market potential at each level of the business hierarchy. Further, some embodiments of TAQS program 120 exploit the hierarchical structure of the organization to enable more effective and efficient optimization solutions.

As a specific example of the above risk-based stochastic target and quota-setting optimization concept within the context of business organization ABC, consider an instance of the first step of the general revenue target and quota-setting process at level k of the business hierarchy, where level k represents the coverage level of the hierarchy and level k−1 represents the customer-set level of the hierarchy, as depicted in FIG. 2. The statistical analysis and models of the previous section provide as input the set of (conditional) probability distributions {D_{(i,j),k}} for every node (i, j) on level k. The targets T_{ζ}_{ₖ}_{(i,j),k-1} at the parent level k−1, i.e., for each customer set, are also provided as input to the risk-based stochastic optimization problem (2.2.1)-(2.2.3),(2.2.4) or its alternative (2.2.1)-(2.2.3),(2.2.5), where ζₖ (i, j) denotes the mapping from node (i, j) on level k to its parent node on (customer-set) level k−1, where the weights w_{(i,j),k} are set according to the relative importance of each coverage node (i, j) from the perspective of its customer set parent node, and where the fairness constraints Fₖ are set according to specific business characterizations and risk profiles for each customer set. In some embodiments, TAQS program 120 computes the solutions of these stochastic optimization problems (as described below) to yield the targets T_{(i,j),k} for each node at the coverage level, together with the likelihood of achieving these targets, which are subsequently mapped down to the account level (see FIG. 2).

To illustrate the computation of such solutions to instances of the general risk-based stochastic optimization formulation, consider a representative scenario in which each D_{(i,j),k} follows a normal distribution with mean μ_{(i,j),k} and standard deviation σ_{(i,j),k} for every node (i, j) on level k. Let Φ(•) and Φ̅(•) denote the cumulative distribution function and complementary cumulative distribution function, respectively, of the standard normal distribution. Assuming the functional of interest to be as given in (2.2.4), the above instance of a general risk-based stochastic optimization problem can be expressed more precisely in the form:

$$\begin{matrix} {max}_{{T}_{k}} {\sum }_{( i , j ) ∈ {S}_{k}}^{ } {w}_{( i , j ) , k} \overline{Φ} ( \frac{{T}_{( i , j ) , k} - {μ}_{( i , j ) , k}}{{σ}_{( i , j ) , k}} ) & ( 2.2 .6 ) \\ s . t . {\sum }_{( i , j ) ∈ {χ}_{k - 1} ( {i}^{′} , {j}^{′} )}^{ } {T}_{( i , j ) , k} = {T}_{( {i}^{′} , {j}^{′} ) , k - 1} , ∀ ( {i}^{′} , {j}^{′} ) ∈ {S}_{k - 1} , & ( 2.2 .7 ) \\ {max}_{( i , j ) ∈ {χ}_{k - 1} ( {i}^{′} , {j}^{′} )} [ \overline{Φ} ( \frac{{T}_{( i , j ) , k} - {μ}_{( i , j ) , k}}{{σ}_{( i , j ) , k}} ) ] - {min}_{( i , j ) ∈ {χ}_{k - 1} ( {i}^{′} , {j}^{′} )} [ \overline{Φ} ( \frac{{T}_{( i , j ) , k} - {μ}_{( i , j ) , k}}{{σ}_{( i , j ) , k}} ) ] \leq {F}_{k} , \\ ∀ ( {i}^{′} , {j}^{′} ) ∈ {S}_{k - 1} . & ( 2.2 .8 )\end{matrix}$$

When considering the alternative functional (2.2.5), certain embodiments employ an approach similar to that above together with the observation that the right-hand side of (2.2.5) is approximated by E[(D_{(i,j),k}−T_{(i,j),k})⁺].

In some embodiments, the mapping of general risk-based stochastic optimization problem, by TAQS program 120, to a refined form for computation, such as the one given in (2.2.6)-(2.2.8), depends, in part, upon the specific solver that is intended for use to compute the optimal solution. In some embodiments, for efficient computation of the optimal solution with certain solvers, the complementary cumulative distribution function Φ̅(•) is approximated by a piecewise linear function. More specifically, outside a small neighborhood of the origin [−z, z] for z small, Φ̅(•) will approach 1 on the negative side and 0 on the positive side. Hence, some embodiments include or construct a piecewise linear function \tilde{Φ}ₘ(•) that takes on the value 1 for x≦−z and the value 0 for x≧z, while taking on m values of Φ̅(•) within (−z, z); the values of z and m can be chosen to achieve the level of precision desired. By replacing Φ̅(•) in both (2.2.6) and (2.2.8) with \tilde{Φ}ₘ(•), a piecewise linear formulation is created whose solution is efficiently computed for large-scale risk-based stochastic optimization problems.

### Subsequent Steps of General Target and Quota Process:

In some embodiments, after TAQS program 120 completes the first step of the general revenue target and quota-setting process via different stakeholders within the business, TAQS program 120 supports a set of subsequent interlock steps of this general process by risk-based stochastic optimization to resolve conflicting revenue targets and simultaneous constraints from these different stakeholder perspectives. In one embodiment, as a general representative instance of such subsequent interlock steps, TAQS program 120 uses risk-based stochastic optimization in the first step to obtain a) the set of targets {T₍ᵢ_{ₚ}_{,j}_{ₚ}_{),k}} for the set of nodes {(iₚ, jₚ)} associated with a particular product line across all geographical regions, and b) the set of targets) {T₍ᵢ_{_{g}}_{,j}_{_{g}}_{),k}} for the set of nodes {(i_{g}, j_{g})} associated with a particular geographical region across all product lines, all on level k of the business hierarchy. In such cases, the target for a common node from the product line perspective will often conflict with the target for the same node from the geographical region perspective. Such conflicts are due to a variety of reasons, including different sets of distributions and constraints from the two stakeholder perspectives.

Focusing on a set of nodes S′ₖ={(i, j)} for a fixed level k of the hierarchy that are common from both the product line and geographical region perspectives, set b₍ᵢ_{ₚ}_{,j}_{ₚ}_{),k}^{p}=T₍ᵢ_{ₚ}_{,j}_{ₚ}_{),k} and b₍ᵢ_{_{g}}_{,j}_{_{g}}_{),k}^{g}=T₍ᵢ_{_{g}}_{,j}_{_{g}}_{),k} with respect to respective first-step risk-based stochastic optimization solutions from the product line and the respective perspectives of geographical region stakeholders. In one embodiment, in this general representative instance of such subsequent interlock steps, TAQS program 120 determines the targets T_{(i,j),k} for every node in the set S′ₖ by minimizing a weighted sum of deviations between the targets and the base values from both the product line and geographical region perspectives according to a norm of interest. More specifically:

$${min}_{{T}_{k}} {\sum }_{( i , j ) ∈ {S}_{k}^{′}}^{ } ‖ {w}_{( i , j ) , k}^{p} ( {b}_{( i , j ) , k}^{p} - {T}_{( i , j ) , k} ) + {w}_{( i , j ) , k}^{g} ( {b}_{( i , j ) , k}^{g} - {T}_{( i , j ) , k} ) ‖ , \qquad ( 2.2 .9 )$$

where Tₖ=(T_{(i,j),kεS′}_{ₖ}) and ∥•∥ denote any one of various norms of interest, which include relative quantities based on different normalizations of the deviation and on utilization of the sets of (conditional) probability distributions {D_{(i,j),k}} or any available statistical information associated with the set of base values.

In one embodiment of TAQS program 120, in addition to the foregoing constraints, such as (2.2.2),(2.2.3) or (2.2.7),(2.2.8), the objective function (2.2.9) is optimized subject to simultaneous overall constraints for each product line across all geographical regions and for each geographical region across all product lines. Let Sₖ^{p} denote the subset of S′ₖ for a particular product line p across all geographical regions and Sₖ^{g} denote the subset of S′ₖ for a particular geographical region g across all product lines. Similarly, let Cₖ^{p} denote the overall constraint for product line p over all geographical regions and Cₖ^{g} denote the overall constraint for geographical region g over all product lines. As such, the formulation of risk-based stochastic optimization problem with objective function (2.2.9) will include the additional constraints for each product line p and each geographical region g of the form:

$${\sum }_{( i , j ) ∈ {S}_{k}^{p}}^{ } {T}_{( i , j ) , k} = {C}_{k}^{p}$$

$$and$$

$${\sum }_{( i , j ) ∈ {S}_{k}^{g}}^{ } {T}_{( i , j ) , k} = {C}_{k}^{g} .$$

In an embodiment, another aspect of the subsequent interlock steps of the general revenue target and quota-setting process of TAQS program 120 includes support from the risk-based stochastic optimization to incorporate sets of parameters that reflect factors such as historical information, business considerations and organizational relationships. As a specific example of one such set of parameters that are accommodated, consider a set of base target levels, {b_{(i,j),k}}, that serve as reference points representing target and quota-settings agreed upon by all the stakeholders under certain circumstances, such as those set in a previous business cycle. The target and quota-setting formulation then takes the form of minimizing a weighted sum of deviations between the targets and the base values with respect to a norm of interest. More specifically:

$${min}_{{T}_{k}} {\sum }_{( i , j ) , , k}^{ } {w}_{( i , j ) , k} ‖ ( {b}_{( i , j ) , k} - {T}_{( i , j ) , k} ‖ \qquad ( 2.2 .10 )$$

subject to all of the foregoing constraints, where Tₖ=(T_{(i,j),k}), the set of weights {w_{(i,j),k}} reflect the relative importance of the base target levels, and ∥•∥ denotes any one of various norms of interest including relative quantities based on different normalizations of the deviation and on utilization of the (conditional) probability distributions {D_{(i,j),k}} or any available statistical information associated with the set of base levels, when available at the desired level of the business hierarchy. However, in some scenarios, for certain levels of the business hierarchy, there may not always be available data of sufficient high quality or of sufficient size that can be used to obtain reasonably high quality estimation of the set of (conditional) probability distributions {D_{(i,j),k}} for the business-market entity nodes (i, j). In these cases, in certain embodiments, the above formulation is utilized with standard norms such as L₁, L₂ and L_{∞}.

As a specific example of the above risk-based stochastic target and quota-setting optimization within the context of business organization ABC, consider an instance of this set of subsequent interlock steps of the general process at level k of the business hierarchy, where level k represents the customer-set level and product brand level of the hierarchy and level k−1 represents both the customer-set and product brand levels of the hierarchy, as depicted in FIG. 3. In this example, TAQS program 120 has respectively obtained the two sets of targets for every customer set and every product brand through aforementioned applications of the first-step risk-based stochastic optimization at levels k−1 of the business hierarchy. Both sets of targets then serve as input for determining the targets at the next lower customer-set and product brand level of the hierarchy. Using an objective in the form of (2.2.10) for each customer set, the summation of all customer-set level and product brand level targets, over all of the customer sets, match the product brand targets and, using an objective in the form of (2.2.10) for each product brand, the summation of all customer-set and product brand level targets over all product brands match the customer-set targets. In one embodiment of TAQS program 120, the base target levels are selected by TAQS program 120 as either combinations of historical revenue values and forecasts or actual targets/quota from the previous business cycle, whereas the weights are set by the corresponding stakeholders to reflect their perspectives on the importance of the base target levels. In some embodiments, the stakeholders also choose from among the various norms described above.

### Section 3:

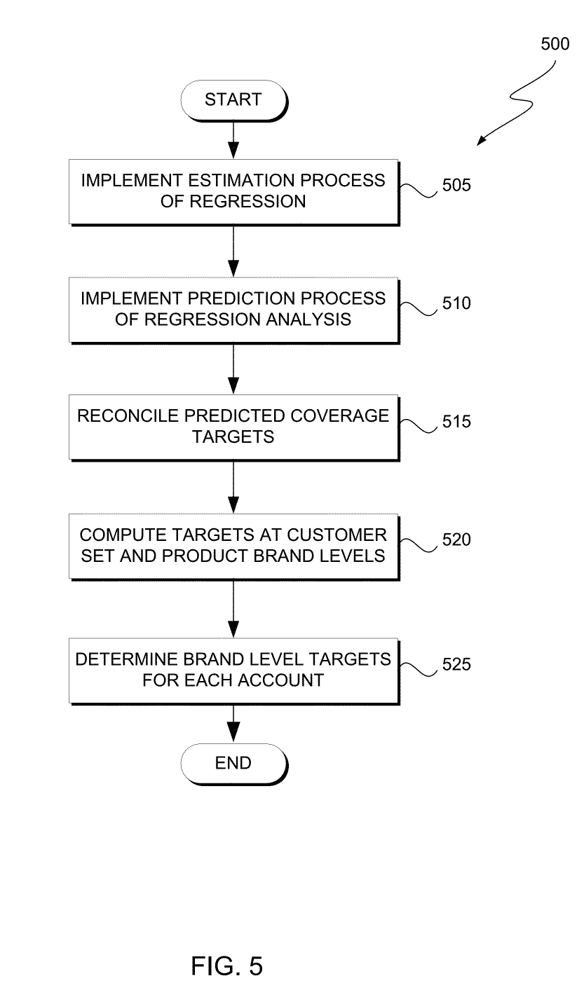

FIG. 5 illustrates operational processes of a target and quota-setting (TAQS) program 120, executing on computing device 110 within the business computing environment 100 of FIG. 1, in accordance with an exemplary embodiment of the present invention.

In processes 505, 510 and 515, TAQS program 120 applies statistical and stochastic optimization methods to calculate revenue targets at the account level of the business hierarchy in accordance with the processes followed in the explanation of INTERLOCK 1 as discussed in sections 1 and 2. In process 505, TAQS program 120 implements the estimation process of regression using historical and opportunity data to compute the coefficients of the regression models at the coverage level, while also providing a report on the statistical quality of these models. As part of this process, TAQS program 120 accesses data repository 125, and retrieves historical and opportunity data for business organization ABC.

In process 510, TAQS program 120 implements the prediction process of regression analysis. In this process, TAQS program 120 computes predicted targets for each customer set using historical data (accessed from data repository 125). TAQS program 120 applies the historical data to the coefficients obtained in the estimation step to compute the predicted targets for each customer set.

In process 515, TAQS program 120 reconciles the predicted coverage targets to budgets at the customer set level by implementing stochastic optimization methods. TAQS program 120 distributes the coverage targets across the contributing business accounts by using proportions corresponding to the contribution of the individual business accounts towards that coverage unit.

In process 520, TAQS program 120 computes targets at the customer set and product brand levels by applying stochastic optimization methods to reconcile the targets given by customer set levels and product brand levels, in accordance with the processes followed in the explanation of INTERLOCK 2 as discussed in sections 1 and 2.

In process 525, TAQS program 120 determines product brand level targets for each account by applying optimization using the output of INTERLOCK 1 (processes 505, 510 and 515) and INTERLOCK 2 (process 520), which consists of account, customer set and product brand targets, in accordance with the processes followed in the explanation of INTERLOCK 3 as discussed in sections 1 and 2.

FIG. 6 depicts a block diagram, 600, of components of computing device 110, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computing device 110 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

TAQS program 120 and data repository 125 are stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices, including resources of network 130. In these examples, communications unit 610 includes one or more network interface cards. Communications unit 610 may provide communications through the use of either or both physical and wireless communications links. TAQS program 120 and data repository 125 may be downloaded to persistent storage 608 through communications unit 610.

I/O interface(s) 612 allows for input and output of data with other devices that may be connected to computing device 110. For example, I/O interface 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., TAQS program 120 and data repository 125, can be stored on such portable computer-readable storage media and can be loaded onto persistent storage 608 via I/O interface(s) 612. I/O interface(s) 612 also connect to a display 620.

Display 620 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method of setting financial targets and quotas across multiple levels of an organizational hierarchy, the method comprising:
determining, by one or more processors, for a business organization, a financial target for a plurality of business accounts across a plurality of product brands that are included in a business account level of an organizational hierarchy of the business organization, wherein the organizational hierarchy includes a plurality of levels;
determining, by one or more processors, one or both of respective financial targets and quotas for a plurality of nodes included in a level of the organizational hierarchy; and
determining, by one or more processors, respective financial targets for one or more combinations of business accounts and product brands, based, at least in part, on at least one of a statistical model that is fitted at a middle level of the organizational hierarchy and a risk-based stochastic optimization that is used to set financial targets and quotas at one or more levels of the organizational hierarchy.

2. The method of claim 1, the method further comprising:
determining, by one or more processors, a plurality of constraints that are imposed by one or both of financial targets at a customer level and a product brand level of the organizational hierarchy; and
generating, by one or more processors, financial targets at one or both of a business account level and a product brand level of the organizational hierarchy by division of one or more financial targets of a business account level of the organizational hierarchy.

3. The method of claim 1, the method further comprising:
generating, by one or more processors, the financial target based, at least in part on a statistical analysis of historical data of the business organization that predicts a likelihood of achieving the financial target.

4. The method of claim 1, the method further comprising:
reconciling, by one or more processors, a predicted financial target to a budget of a customer level of the organizational hierarchy by implementing stochastic optimization methods.

5. The method of claim 1, the method further comprising:
distributing, by one or more processors, a financial target across one or more business accounts that contribute to that financial target, wherein the distribution is based, at least in part, on the respective contribution of an individual business account.

6. The method of claim 1, the method further comprising:
determining, by one or more processors, respective financial targets at a customer level and product brand level of the organizational hierarchy, by applying stochastic optimization methods to reconcile a plurality of financial targets given by one or more customer level and product brand level of the organizational hierarchy.

7. The method of claim 1, the method further comprising:
determining, by one or more processors, at a product brand level of the organizational hierarchy, financial targets for one or more business accounts by applying an optimization process using respective financial targets of business accounts, business customers, and product brands.

8. A computer program product for setting financial targets and quotas across multiple levels of an organizational hierarchy, the computer program product comprising:
one or more computer-readable storage media and program instructions stored on the one or more computer-readable storage media, the program instructions comprising:
program instructions to determine for a business organization, a financial target for a plurality of business accounts across a plurality of product brands that are included in a business account level of an organizational hierarchy of the business organization, wherein the organizational hierarchy includes a plurality of levels;
program instructions to determine one or both of respective financial targets and quotas for a plurality of nodes included in a level of the organizational hierarchy; and
program instructions to determine respective financial targets for one or more combinations of business accounts and product brands, based, at least in part, on at least one of a statistical model that is fitted at a middle level of the organizational hierarchy and a risk-based stochastic optimization that is used to set financial targets and quotas at one or more levels of the organizational hierarchy.

9. The computer program product of claim 8, the program instructions further comprising:
program instructions to determine a plurality of constraints that are imposed by one or both of financial targets at a customer level and a product brand level of the organizational hierarchy; and
program instructions to generate financial targets at one or both of a business account level and a product brand level of the organizational hierarchy by division of one or more financial targets of a business account level of the organizational hierarchy.

10. The computer program product of claim 8, the program instructions further comprising:
program instructions to generate the financial target based, at least in part on a statistical analysis of historical data of the business organization that predicts a likelihood of achieving the financial target.

11. The computer program product of claim 8, the program instructions further comprising:
program instructions to reconcile a predicted financial target to a budget of a customer level of the organizational hierarchy by implementing stochastic optimization methods.

12. The computer program product of claim 8, the program instructions further comprising:
program instructions to distribute a financial target across one or more business accounts that contribute to that financial target, wherein the distribution is based, at least in part, on the respective contribution of an individual business account.

13. The computer program product of claim 8, the program instructions further comprising:
program instructions to determine respective financial targets at a customer level and product brand level of the organizational hierarchy, by applying stochastic optimization methods to reconcile a plurality of financial targets given by one or more customer level and product brand level of the organizational hierarchy.

14. The computer program product of claim 8, the program instructions further comprising:
program instructions to determine at a product brand level of the organizational hierarchy, financial targets for one or more business accounts by applying an optimization process using respective financial targets of business accounts, business customers, and product brands.

15. A computer system for setting financial targets and quotas across multiple levels of an organizational hierarchy, the computer system comprising:
one or more computer processors;
one or more computer readable storage medium;
program instructions stored on the computer readable storage medium for execution by at least one of the one or more processors, the program instructions comprising:
program instructions to determine for a business organization, a financial target for a plurality of business accounts across a plurality of product brands that are included in a business account level of an organizational hierarchy of the business organization, wherein the organizational hierarchy includes a plurality of levels;
program instructions to determine one or both of respective financial targets and quotas for a plurality of nodes included in a level of the organizational hierarchy; and
program instructions to determine respective financial targets for one or more combinations of business accounts and product brands, based, at least in part, on at least one of a statistical model that is fitted at a middle level of the organizational hierarchy and a risk-based stochastic optimization that is used to set financial targets and quotas at one or more levels of the organizational hierarchy.

16. The computer system of claim 15, the program instructions further comprising:
program instructions to determine a plurality of constraints that are imposed by one or both of financial targets at a customer level and a product brand level of the organizational hierarchy; and
program instructions to generate financial targets at one or both of a business account level and a product brand level of the organizational hierarchy by division of one or more financial targets of a business account level of the organizational hierarchy.

17. The computer system of claim 15, the program instructions further comprising:
program instructions to generate the financial target based, at least in part on a statistical analysis of historical data of the business organization that predicts a likelihood of achieving the financial target.

18. The computer system of claim 15, the program instructions further comprising:
program instructions to distribute a financial target across one or more business accounts that contribute to that financial target, wherein the distribution is based, at least in part, on the respective contribution of an individual business account.

19. The computer system of claim 15, the program instructions further comprising:
program instructions to determine respective financial targets at a customer level and product brand level of the organizational hierarchy, by applying stochastic optimization methods to reconcile a plurality of financial targets given by one or more customer level and product brand level of the organizational hierarchy.

20. The computer system of claim 15, the program instructions further comprising:
program instructions to determine at a product brand level of the organizational hierarchy, financial targets for one or more business accounts by applying an optimization process using respective financial targets of business accounts, business customers, and product brands.
